(19) United States
(12) Patent Application Publication
(10) Pub. No.: US 2022/0191587 A1
(43) Pub. Date: Jun. 16, 2022

(54) RECEIVER, RECEPTION METHOD, AND RECEPTION PROGRAM

(71) Applicant: SONY SEMICONDUCTOR SOLUTIONS CORPORATION, KANAGAWA (JP)

(72) Inventor: KENICHI KOBAYASHI, KANAGAWA (JP)

(21) Appl. No.: 17/442,847

(22) PCT Filed: Mar. 10, 2020
(86) PCT No.: PCT/JP2020/010297

§ 371 Date: Sep. 24, 2021

(30) Foreign Application Priority Data
Apr. 5, 2019 (JP) 2019-073105

(51) Int. Cl. H04N 21/443; H04N 21/426; H04N 21/81

(52) U.S. Cl. CPC H04N 21/4436; H04N 21/814; H04N 21/42607

(57) ABSTRACT

A receiver (20) includes a processing unit (22) that processes a received signal including a plurality of frames, a section identification unit (25) that identifies a first section being a bootstrap in each of the frames based on the received signal, and a control unit (26) that operates the processing unit (22) in the first section of the frame and does not operate the processing unit (22) in a second section of the frame different from the first section during a standby state.

### FIELD

The present disclosure relates to a receiver, a reception method, and a reception program.

### BACKGROUND

Advanced Television Systems Committee (ATSC) 3.0 that is one of the next generation broadcasting standards is being developed. Patent Literature 1 discloses a data processing device that performs processing of signaling so that the signaling is included in a preamble of a physical layer frame, reducing a processing load on a reception side.

### CITATION LIST

### Patent Literature

Patent Literature 1: JP 2017-135557 A

### SUMMARY

### Technical Problem

In ATSC 3.0, an emergency signal notifying of emergency information (emergency alert system (EAS)) is periodically applied to a bootstrap signal at the head of a frame. A receiver needs to continue to receive the emergency information even while not receiving a broadcast signal. Therefore, there is room for improvement in technology for receiving the emergency information.

Therefore, the present disclosure proposes a receiver, a reception method, and a program that are configured to receive emergency information while suppressing power consumption in a standby state.

### Solution to Problem

To solve the problems described above, a receiver includes: a processing unit that processes a received signal including a plurality of frames; a section identification unit that identifies a first section being a bootstrap in each of the frames based on the received signal; and a control unit that operates the processing unit in the first section of the frame and does not operate the processing unit in a second section of the frame different from the first section during a standby state.

Moreover, a reception method performed by a receiver including a processing unit that processes a received signal including a plurality of frames includes: a step pf identifying a first section being a bootstrap in each of the frames based on the received signal; and a step pf operating the processing unit in the first section of the frame and not operating the processing unit in a second section of the frame different from the first section during a standby state.

Moreover, a reception program causes a receiver including a processing unit that processes a received signal including a plurality of frames to perform a step pf identifying a first section being a bootstrap in each of the frames based on the received signal, and a step pf operating the processing unit in the first section of the frame and not operating the processing unit in a second section of the frame different from the first section during a standby state.

### BRIEF DESCRIPTION OF DRAWINGS

FIG. 1 is a diagram illustrating an ATSC 3.0 frame structure.

FIG. 2 is a table illustrating a configuration of bootstrap signaling.

FIG. 3 is a diagram illustrating a configuration of a transmission system according to a first embodiment.

FIG. 4 is a diagram illustrating a configuration of a receiver according to the first embodiment.

FIG. 5 is a flowchart illustrating an example of a procedure performed by the receiver according to the first embodiment.

FIG. 6 is a table illustrating an example of L1 basic information according to the first embodiment.

FIG. 7 is a table illustrating an example of L1 detail information according to the first embodiment.

FIG. 8 is a table illustrating an example of fft_size in FIGS. 6 and 7.

FIG. 9 is a table illustrating an example of guard_interval of FIGS. 6 and 7.

FIG. 10 is a diagram illustrating an example of a definition of a frame length according to the first embodiment.

FIG. 11 is a diagram illustrating the operation of the receiver according to the first embodiment.

FIG. 12 is a diagram illustrating a configuration of a receiver according to a second embodiment.

FIG. 13 is a table illustrating a setting example of a minimum time interval of a bootstrap.

FIG. 14 is a flowchart illustrating an example of a procedure performed by the receiver according to the second embodiment.

FIG. 15 is a block diagram illustrating a configuration example of the hardware of a computer that performs a series of the processing described above by using a program.

### DESCRIPTION OF EMBODIMENTS

Embodiments of the present disclosure will be described below in detail with reference to the drawings. Note that in each of the following embodiments, the same portions are denoted by the same reference symbols, and a repetitive description thereof will be omitted.

<Overview of Frame in Next Generation Broadcasting Standard>

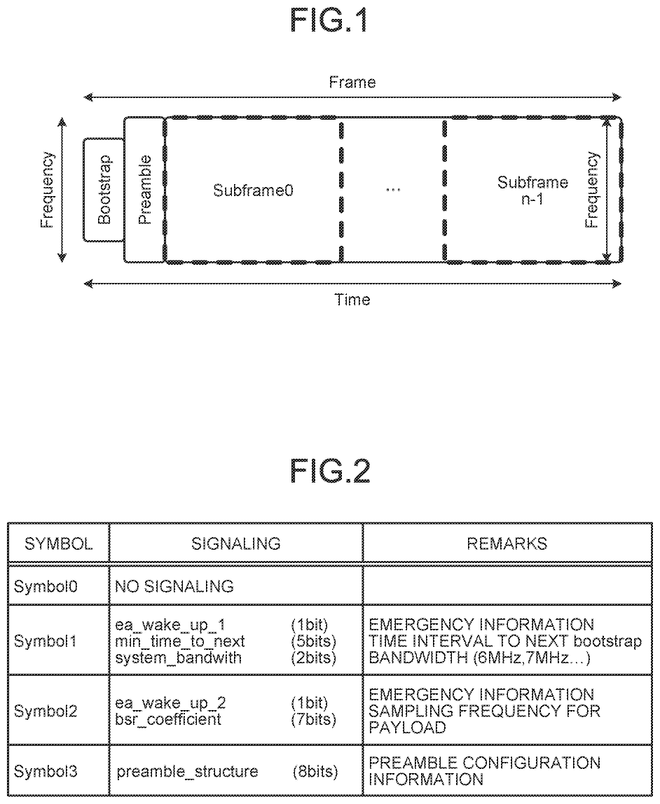

First, an ATSC 3.0 frame structure will be described. ATSC 3.0 is one of the next generation broadcasting standards. FIG. 1 is a diagram illustrating the ATSC 3.0 frame structure. In FIG. 1, the horizontal direction represents time, and the vertical direction represents frequency.

In the broadcasting standards, frames (physical frames) are defined as units for data transfer. In each of the frames, a plurality of subframes including data is arranged. For example, the frame defined in ATSC 3.0 includes a bootstrap, a preamble, and one or more subframes. The frame has a predetermined frame length in milliseconds or the like. The frame is configured so that the subframes can be obtained after acquiring the bootstrap and the preamble.

The bootstrap corresponds to, for example, a P1 symbol constituting a T2 frame in Digital Video Broadcasting-Second Generation Terrestrial (DVB-T2). The preamble corresponds to, for example, a P2 symbol constituting the T2 frame in DVB-T2. Therefore, it can also be said that the bootstrap is the preamble.

The preamble is configured to include L1 signaling such as L1 basic information (L1-Basic) and L1 detail information (L1-Detail). Here, comparing the L1 basic information with the L1 detail information, the L1 basic information is different from the L1 detail information in that the L1 basic information has a size of approximately 200 bits but the L1 detail information has a size of approximately 400 to several thousand bits. Furthermore, in the preamble, the L1 basic information and the L1 detail information are read in this order, and thus, the L1 basic information is read earlier than the L1 detail information. Furthermore, the L1 basic information is also different from the L1 detail information in that the L1 basic information is more robust for transmission (robustness).

In the subframes, payload (data) is arranged. In a case where the frame includes two or more subframes, various control parameters such as an FFT size, pilot pattern, and guard interval length are allowed to be changed for each subframe.

<Bootstrap Signaling>

FIG. 2 is a table illustrating a configuration of bootstrap signaling. As illustrated in FIG. 2, the signaling includes four symbols of Symbol 0, Symbol 1, Symbol 2, and Symbol 3.

Symbol 0 represents no signaling. Symbol 1 includes ea_wake_up_1 (1 bit), min_time_to_next (5 bits), and system_bandwith (2 bits) in the signaling. The value of ea_wake_up_1 is used for notification of emergency information. The value of min_time_to_next is used for notification of a time interval to the next bootstrap. The value of ystem_bandwith is used for notification of a bandwidth (e.g., 6 MHz, 7 MHz, or the like). Symbol 2 includes ea_wake_up_2 (1 bit) and bsr_coefficient (7 bits) in the signaling. The value of ea_wake_up_2 is used for notification of the emergency information. The value of bsr_coefficient is used for notification of a sampling frequency for the payload. Symbol 3 includes preamble_structure (8 bits) in the signaling. The value of preamble_structure is used for notification of preamble configuration information.

### First Embodiment

[Transmission System Configuration]

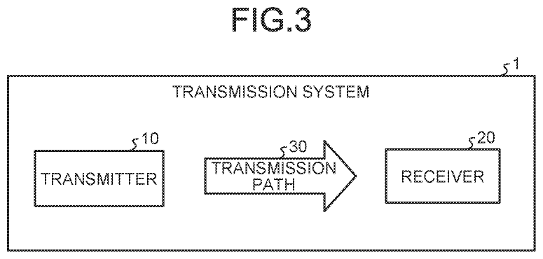

FIG. 3 is a diagram illustrating a configuration of a transmission system according to a first embodiment. As illustrated in FIG. 3, a transmission system 1 includes a transmitter 10 and a receiver 20. The transmission system 1 performs data transmission in conformity with a digital broadcasting standard adopting an IP transmission method such as ATSC 3.0.

The transmitter 10 transmits content via a transmission path 30. For example, the transmitter 10 transmits, as a digital broadcast signal, a broadcast stream containing components such as video and audio constituting content, such as a TV program, and signaling, via the transmission path 30.

The receiver 20 receives and outputs the broadcast signal transmitted from the transmitter 10 via the transmission path 30. For example, the receiver 20 receives the digital broadcast signal from the transmitter 10, acquires the components constituting the content and the signaling from the broadcast stream, and reproduces the video and audio of the content.

Note that, in the transmission system 1, the transmission path 30 is not limited to ground waves. For example, the transmission path 30 may be a radio channel other than the ground waves such as the satellite waves used for satellite broadcasting. Furthermore, the transmission path 30 may be a wired line such as a cable used for cable broadcasting.

### Overview of Present Embodiment

In ATSC 3.0, an emergency signal notifying of the emergency information (EAS) is periodically applied to the bootstrap, for transmission. Therefore, the receiver 20 needs to continue to receive the emergency signal even in a standby state in which broadcast content is not received (an EAS reception mode). The standby state includes, for example, a state in which no broadcast content is received but a broadcast signal (received signal) is received. The standby state includes, for example, a state in which no power is supplied during normal operation of the receiver. In the present embodiment, the receiver 20 is implemented that is configured to suppress power consumption even if the broadcast signal is continuously received in the standby state (the EAS reception mode).

The receiver 20 is a device that receives the signal transmitted from the transmitter 10. For example, the receiver 20 is an ATSC 3.0 receiver. Note that the receiver 20 is not limited to the ATSC 3.0 receiver and may be a receiver for another broadcasting standard such as DVB or ISDB. Furthermore, the receiver 20 may be a receiver for radio communication. For example, the receiver 20 may be a receiver that is configured to receive communication using a radio access technology such as LTE or NR radio communication.

Examples of the receiver 20 include a TV set and a radio set. As a manner of course, the receiver 20 is not limited to the TV set and the radio set and may be a terminal device such as a mobile phone, a smart device (smartphone or tablet), a wearable terminal, a personal digital assistant (PDA), or a personal computer.

Furthermore, the receiver 20 may be a conversion device that converts information transmitted by a predetermined broadcast system (or a predetermined communication system) into information for another broadcast system (or another communication system). For example, the receiver 20 may be a device that converts content (e.g., a TV program) broadcasted on the basis of a new broadcast system into content (e.g., a TV program) for a conventional broadcast system and transmits the content to a conventional receiver.

Furthermore, the receiver 20 may be a video recorder or an audio recorder that records received video or audio. Furthermore, the receiver 20 may be a machine to machine (M2M) device or an Internet of things (IoT) device. The receiver 20 may have a transmission function.

[Configuration of Receiver]

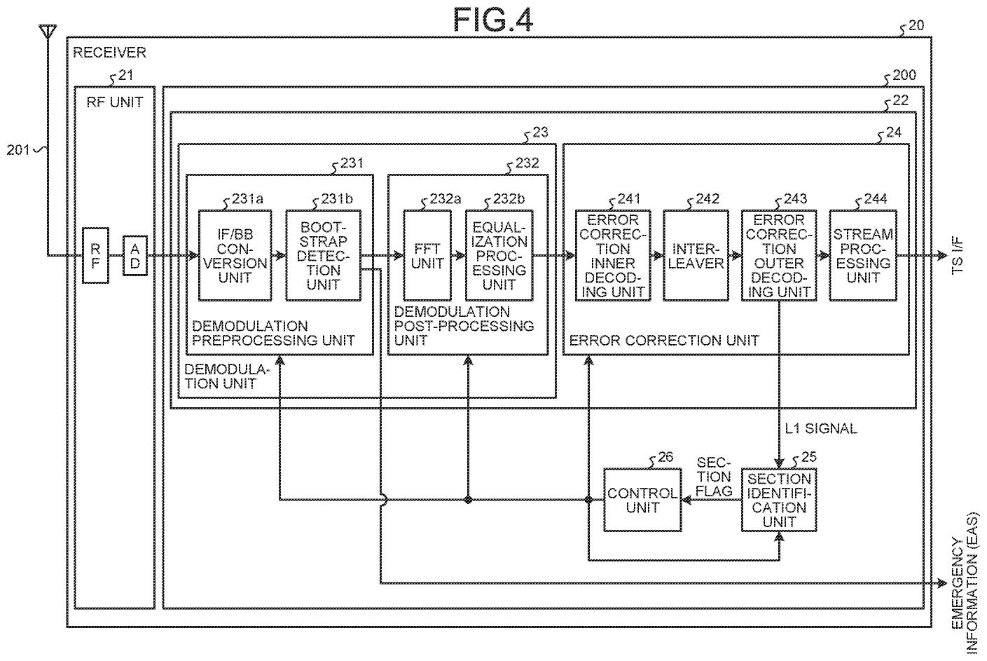

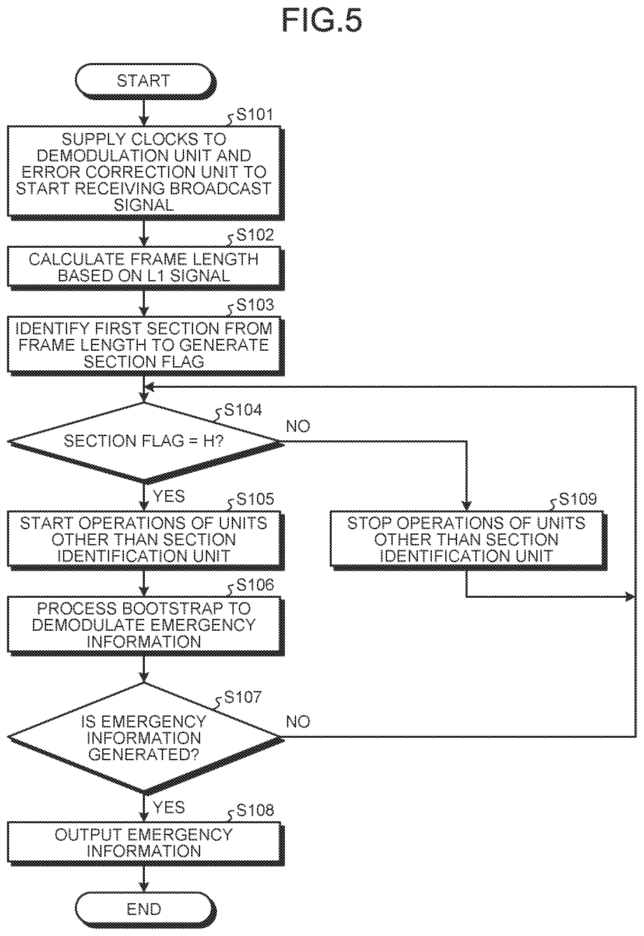

Hereinafter, a configuration of the receiver 20 will be described in detail. FIG. 4 is a diagram illustrating the configuration of the receiver 20 according to the first embodiment. As illustrated in FIG. 4, the receiver 20 includes a radio frequency (RF) unit 21, a processing unit 22, a section identification unit 25, and a control unit 26. The processing unit 22 includes a demodulation unit 23 and an error correction unit 24. The processing unit 22, the section identification unit 25, and the control unit 26 are implemented by a digital circuit 200. In the present embodiment, the processing unit 22 of the receiver 20 that includes the demodulation unit 23 and the error correction unit 24 will be described but the processing unit 22 may include, for example, the section identification unit 25.

The RF unit 21 is connected to an antenna 201 and receives an RF signal transmitted from the transmitter 10 via the transmission path 30. The RF unit 31 converts the received RF signal to a digital signal by A/D conversion, and supplies the digital signal to the demodulation unit 23.

The demodulation unit 23 includes a demodulation preprocessing unit 231 and a demodulation post-processing unit 232. The demodulation preprocessing unit 231 includes an IF/BB conversion unit 231a and a bootstrap detection unit 231b. The IF/BB conversion unit 231a quadrature demodulates the signal supplied by the RF unit 21 and obtains a baseband orthogonal frequency division multiplexing (OFDM) signal from a result of the quadrature demodulation. The bootstrap detection unit 331b demodulates the bootstrap from the OFDM signal, and outputs the emergency information to the outside of the receiver 20 when the emergency information is notified of in the demodulated bootstrap. The bootstrap detection unit 331b supplies the OFDM signal to the demodulation post-processing unit 232.

The demodulation post-processing unit 232 includes an FFT unit 232a and an equalization processing unit 232b. The FFT unit 232a receives the OFDM signal input from the demodulation preprocessing unit 231. The FFT unit 232a performs a fast Fourier transform (FFT) operation on the OFDM signal and extracts data that is subjected to orthogonal transformation into subcarriers. The equalization processing unit 232b performs equalization that is predetermined frequency domain processing, on the OFDM signal supplied from the FFT unit 232a, and supplies data obtained by the equalization processing to the error correction unit 24 in the subsequent stage.

The error correction unit 24 includes an error correction inner decoding unit 241, an interleaver 242, an error correction outer decoding unit 243, and a stream processing unit 244. The error correction inner decoding unit 241 supplies data obtained by decoding the OFDM signal by a predetermined modulation method to the interleaver 242. The interleaver 242 supplies the data after interleaving to the error correction outer decoding unit 243. The error correction outer decoding unit 243 supplies the data decoded by decoding an error correction outer code, to the stream processing unit 244. The error correction outer decoding unit 243 extracts an L1 signal including the L1 basic information and the like from the received signal, and supplies the L1 signal to the section identification unit 25. The stream processing unit 244 processes a stream of the data and supplies stream data to a transport stream (TS) interface or the like.

The section identification unit 25 identifies a bootstrap section in the frame, on the basis of the received signal. For example, the section identification unit 25 calculates the frame length of the frame on the basis of the L1 basic information of the L1 signal supplied by the error correction unit 24, and identifies a first section being the bootstrap in the frame having the frame length. The first section is the bootstrap section in the frame. The first section is a section driving the processing unit 22. Note that the first section may be the entire section of the bootstrap in the frame, or may be a section from which the emergency information can be extracted. A method of identifying the section will be described later. Furthermore, after the first section is identified, the remaining section of the frame becomes a second section. The second section can be all or part of a section different from the first section of the frame.

The section identification unit 25 supplies a section flag indicating the first section to the control unit 26. The section flag is, for example, a flag indicating whether a portion of the frame is the first section or the second section. For example, the section flag may include flags, for regions provided from the head to the tail end of the frame at equal intervals. For example, the section identification unit 25 supplies, to the control unit 26, the section flags indicating the first section of the frame as “H” and the second section different from the first section as “L”.

The control unit 26 is a controller that controls each unit of the receiver 20. The control unit 26 operates the processing unit 22 in the first section of the frame and does not operate the processing unit 22 in the second section of the frame different from the first section, during the standby state. In other words, during the standby state, the control unit 26 causes the processing unit 22 to perform processing in the first section of the frame, and does not cause the processing unit 22 to perform processing in the second section of the frame different from the first section. The control unit 26 controls operations of the demodulation preprocessing unit 231, the demodulation post-processing unit 232, the error correction unit 24, and the section identification unit 25, on the basis of the section flags from the section identification unit 25.

The control unit 26 is configured to supply clocks to the demodulation preprocessing unit 231, the demodulation post-processing unit 232, the error correction unit 24, and the section identification unit 25. For example, the control unit 26 causes a clock source such as a transmitter to generate the clock. In the present embodiment, the control unit 26 causes the demodulation preprocessing unit 231, the demodulation post-processing unit 232, the error correction unit 24, and the section identification unit 25 to operate (function) by supplying the clocks thereto. In other words, the control unit 26 is configured to stop the operation of each unit by supplying no clock to the demodulation preprocessing unit 231, the demodulation post-processing unit 232, and the error correction unit 24.

The configuration example of the receiver 20 according to the embodiment has been described above. Note that the configuration described above with reference to FIG. 4 is merely an example, and the configuration of the receiver 20 according to the first embodiment is not limited to such an example. The functional configuration of the receiver 20 according to the first embodiment can be flexibly modified according to specifications and operations.

### Procedure Performed by Receiver According to First Embodiment

Next, an example of a procedure performed by the receiver 20 according to the first embodiment will be described with reference to FIG. 5. FIG. 5 is a flowchart illustrating an example of the procedure performed by the receiver 20 according to the first embodiment. The procedure illustrated in FIG. 5 is implemented by execution of a program during the standby state of the receiver 20. The procedure illustrated in FIG. 5 is not performed while the receiver 20 receives the broadcast content. The procedure illustrated in FIG. 5 is performed while the section identification unit 25 is operating.

As illustrated in FIG. 5, the receiver 20 supplies the clocks to the demodulation unit 23, the error correction unit 24, and the like to start receiving the broadcast signal (Step S101). Therefore, the receiver 20 starts receiving the ATSC 3.0 broadcast signal (received signal). The receiver 20 calculates the frame length on the basis of the L1 signal (Step S102). For example, the receiver 20 demodulates the received signal and calculates the frame length on the basis of the L1 basic information, the L1 detail information, and the like of the L1 signal after error correction. Note that a method of calculating the frame length will be described later. Then, the receiver 20 identifies the first section from the frame length on the basis of the L1 basic information to generate the section flag (Step S103). When the processing in Step S103 is finished, the receiver 20 proceeds to Step S104.

The receiver 20 determines whether the section flag indicates “H” (Step S104). For example, when the section flag changes from “L” to “H”, the receiver 20 may determine that the section flag indicates “H”. When it is determined that the section flag indicates “H” (Yes in Step S104), the frame of the broadcast signal represents the first section, and thus, the receiver 20 proceeds to Step S105.

The receiver 20 starts the operations of the units other than the section identification unit 25 (Step S105). For example, since the section identification unit 25 is operating, the receiver 20 supplies clocks to the demodulation unit 23 and the error correction unit 24 to start the operations thereof. The receiver 20 processes the bootstrap to demodulate the emergency information (Step S106). For example, in the receiver 20, the bootstrap detection unit 231b decodes the bootstrap of the broadcast signal. For example, in a case where the bootstrap is not notified of, the receiver 20 does not demodulate the emergency information.

The receiver 20 determines whether the emergency information is generated (Step S107). The receiver 20 determines whether the emergency information is generated on the basis of ea_wake_up_1 or the like in the bootstrap signaling. The receiver 20 determines that the emergency information is generated upon notification of the emergency information in the bootstrap signaling. When it is determined that the emergency information is not generated (No in Step S107), the receiver 20 returns to Step S104, which has already been described, and repeats the processing in Step S104 and subsequent steps. When it is determined that the emergency information is generated (Yes in Step S107), the receiver 20 proceeds to Step S108.

The receiver 20 outputs the emergency information (Step S108). For example, the receiver 20 outputs the emergency information that is extracted from the broadcast signal by the bootstrap detection unit 231b. When the processing in Step S108 is finished, the receiver 20 finishes the procedure illustrated in FIG. 5.

When it is determined that the section flag does not indicate “H” (No in Step S104), the frame of the broadcast signal does not represent the first section, and thus, the receiver 20 proceeds to Step S109. The receiver 20 stops the operations of the units other than the section identification unit 25 (Step S109). For example, the receiver 20 stops the supply of the clocks to the demodulation unit 23 and the error correction unit 24 to stop the operations thereof. Note that, in a case where the operations have already been stopped, the receiver 20 does not perform the processing in Step S109. Then, when the processing in Step S109 is finished, the receiver 20 returns to Step S104, which has already been described, and repeats the processing in Step S104 and subsequent steps.

[Method of Calculating ATSC 3.0 Frame Length]

Next, the method of calculating an ATSC 3.0 frame length that is performed by the receiver 20 will be described. The ATSC 3.0 frame length can be calculated by using specific signaling of the bootstrap, the L1 basic information, and L1 detail information. For example, in the bootstrap, bsr_coefficient included in the signaling for Symbol 2 described above can be used for calculating the frame length. An elementary period (baseband signal sampling interval) can be obtained from the value of bsr_coefficient. For example, when bsr_coefficient is “2”, the elementary period is “0.1447”. For example, when bsr_coefficient is “5”, the elementary period is “0.1240”. For example, when bsr_coefficient is “8”, the elementary period is “0.1085”.

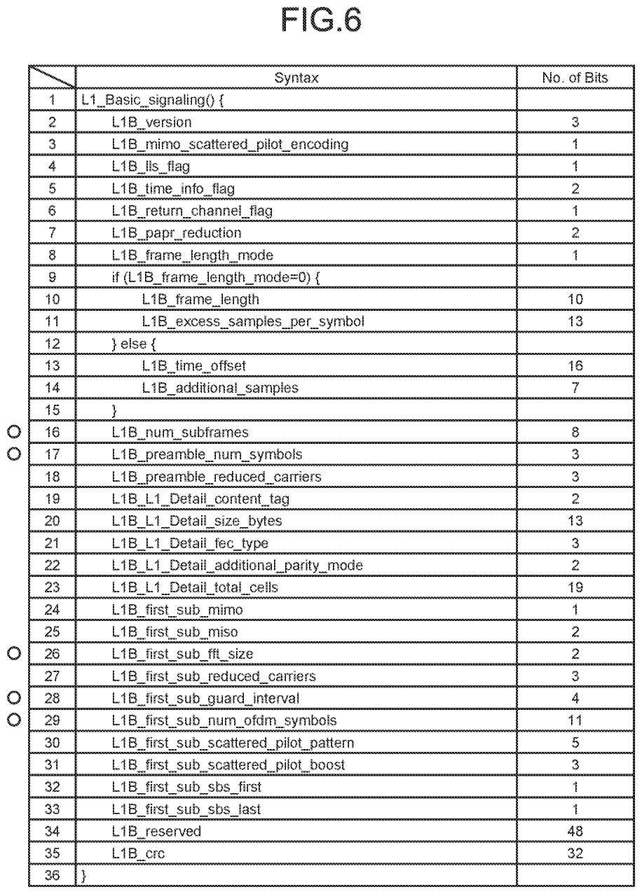

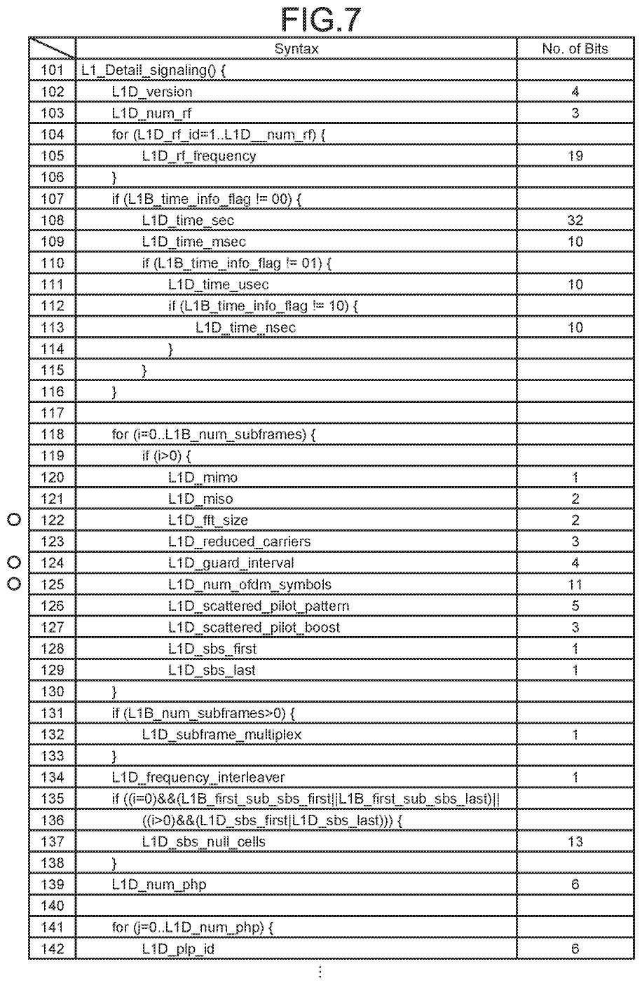

FIG. 6 is a table illustrating an example of the L1 basic information according to the first embodiment. FIG. 7 is a table illustrating an example of the L1 detail information according to the first embodiment. In FIGS. 6 and 7, the numbers in the leftmost column indicate line numbers. The line numbers are associated with Syntax and No. of Bits.

The receiver 20 uses information set in L1B_num_subframes (line number 16), L1B_preamble_num_symbols (line number 17), L1B_first_sub_fft_size (line number 26), L1B_first_sub_guard_interval (line number 28), and L1B_first_sub_num_ofdm_symbols (line number 29) of the L1 basic information illustrated in FIG. 6, for the calculation of the frame length.

The receiver 20 uses information set in L1D_fft_siza (line number 122), L1D_guard_interval (line number 124), and L1D_num_ofdm_symbols (line number 125) of the L1 detail information illustrated in FIG. 7, for the calculation of the frame length.

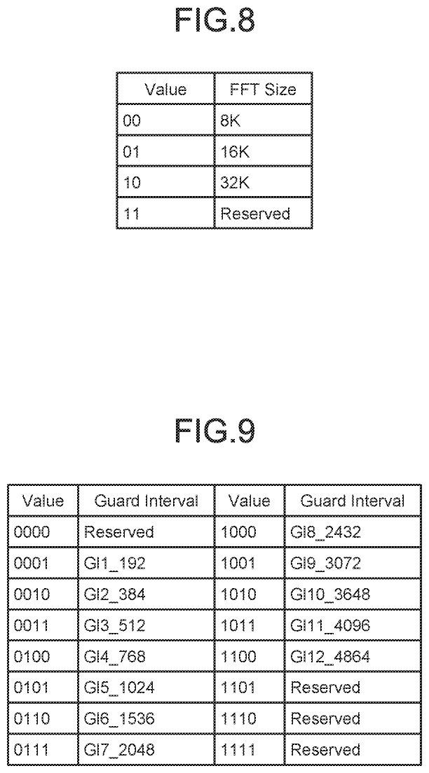

FIG. 8 is a table illustrating an example of fft_size in FIGS. 6 and 7. In L1B_first_sub_fft_size of the L1 basic information and L1D_fft_siza of the L1 detail information, values as illustrated in FIG. 8 are set. For example, the values “00” for 8K, “01” for 16K, and “10” for 32K are set to fft_size. For example, when fft_size is set to “00”, the receiver 20 recognizes that 8K, that is, 8192 is the size of fft. For example, when fft_size is set to “01”, the receiver 20 recognizes that 16K, that is, 16384 is the length of fft.

FIG. 9 is a table illustrating an example of guard_interval of FIGS. 6 and 7. The values as illustrated in FIG. 9 are set to L1B_first_sub_guard_interval of the L1 basic information and L1D_guard_interval of the L1 detail information. For example, the value of “0001” for G11_192 and the value of “0010” for G12 384 are set to guard_interval. For example, when “0001” is set to guard_interval, the receiver 20 recognizes that G11_192, that is, 192 is the length of guard_interval.

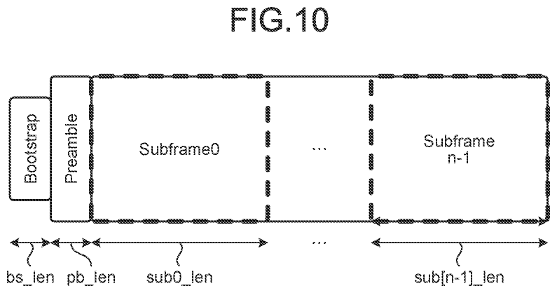

FIG. 10 is a diagram illustrating an example of a definition of the frame length according to the first embodiment. As illustrated in FIG. 10, the receiver 20 defines a length of the bootstrap (bs_len), a length of the preamble (pb_len), a length of a subframe 0 (sub0_len), . . . a length of a subframe n−1 (sub[n−1] len), in the frame. The receiver 20 calculates the length of the bootstrap as a fixed value of 12288.

The receiver 20 substitutes the values of L1B_preamble_num_symbols, L1B_first_sub_fft_size, and L1B_first_sub_guard_interval of the L1 basic information into the following (Formula 1) to calculate the length of the preamble (pb_len).

pb_len={fft_point(L1B_first_sub_fft_size)+gi_len(L1B_first_sub_guard_interval)}×(L1B_preamble_num_symbols+1) (Formula 1)

The receiver 20 substitutes the values of L1B_first_sub_fft_size, L1B_first_sub_guard_interval, and L1B_first_sub_num_symbols of the L1 basic information into the following (Formula 2) to calculate the length (sub0_len) of the subframe 0.

sub0_len={fft_point(L1B_first_sub_fft_size)+gi_len(L1B_first_sub_guard_interval)}×(L1B_first_sub_num_symbols+1) (Formula 2)

The receiver 20 substitutes the values of L1D_fft_size, L1D_guard_interval, and L1D_num_symbols of the L1 detail information into the following (Formula 3) to calculate the length of the subframe n−1 (sub[n−1] len).

sub[n−1]_len={fft_point(L1D_fft_size)+gi_len(L1D_guard_interval)}×(L1D_num_symbols+1) (Formula 3)

Note that in the above (Formula 1) to (Formula 3), fft_point represents a function for calculating the length on the basis of the table of fft_size which is described above. Furthermore, gi_len represents a function for calculating the length on the basis of the table of guard_interval which is described above.

The receiver 20 substitutes the calculated length of the preamble (pb_len), length of the subframe 0 (sub0_len), and length of the subframe n−1 (sub[n−1] len) into the following (Formula 4) to calculate the ATSC 3.0 frame length [us].

$$Frame length [ us ] = ( \begin{matrix}bs\_len + pb\_len + sub 0 \_len + \\ {\sum }_{i = 1}^{L 1 B\_num \_subframes} sub [ i ] \_len\end{matrix} ) \times Elementary\_period \qquad ( Formula 4 )$$

### Operation of Receiver According to First Embodiment

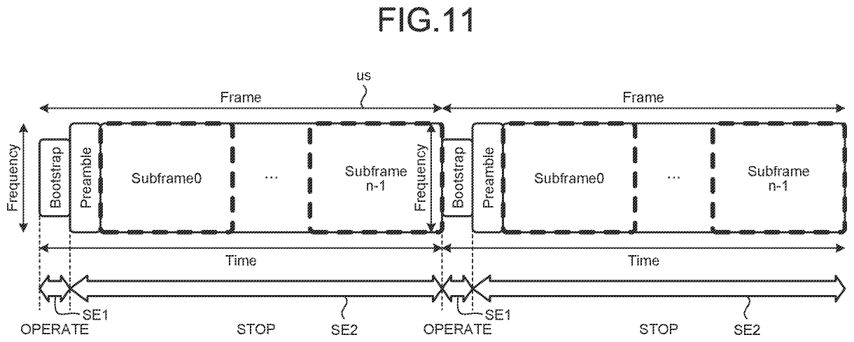

Next, an example of the operation of the receiver 20 according to the first embodiment will be described with reference to FIG. 11. FIG. 11 is a diagram illustrating the operation of the receiver 20 according to the first embodiment. In the example illustrated in FIG. 11, during the standby state, the receiver 20 receives the broadcast signal, demodulation thereof is performed by the demodulation unit 23, and error correction thereof is performed by the error correction unit 24. The receiver 20 calculates the frame length us of the frame, on the basis of the lengths of the bootstrap, preamble, and plurality of subframes included in the frame. The receiver 20 identifies the first section SE1 in the frame by using the section identification unit 25. In other words, the receiver 20 defines the length of the bootstrap from the head of the frame length us as the first section SE1, and defines the other section after the first section SE1 as the second section SE2. In the receiver 20, when the frame length is determined from the received signal, the position of the bootstrap in the frame is determined. Therefore, for the subsequent received signals, the receiver 20 is configured so that the control unit 26 causes the demodulation unit 23, the error correction unit 24, and the section identification unit 25 to operate, in the first section SE1 for each frame. The receiver 20 is configured so that the control unit 26 stops the operations of the demodulation unit 23 and the error correction unit 24 and operates the section identification unit 25, in the second section SE2 for each frame. Accordingly, during the standby state, the receiver 20 is operable to stop the operations of the demodulation unit 23 and the error correction unit 24 in the second section of the frame, suppressing the power consumption, as compared with operating the demodulation unit 23 and the error correction unit 24 at all times.

### Second Embodiment

In the first embodiment, identification of the first section being the bootstrap on the basis of the frame length of the frame by the receiver 20 has been described, but the present invention is not limited thereto. For example, as illustrated in FIG. 2, in the bootstrap, Symbol 1 includes min_time_to_next (5 bits) in the signaling. In a second embodiment, an example will be described in which the receiver 20 identifies the first section on the basis of a time interval to the next bootstrap that is set in the bootstrap.

### Configuration of Receiver According to Second Embodiment

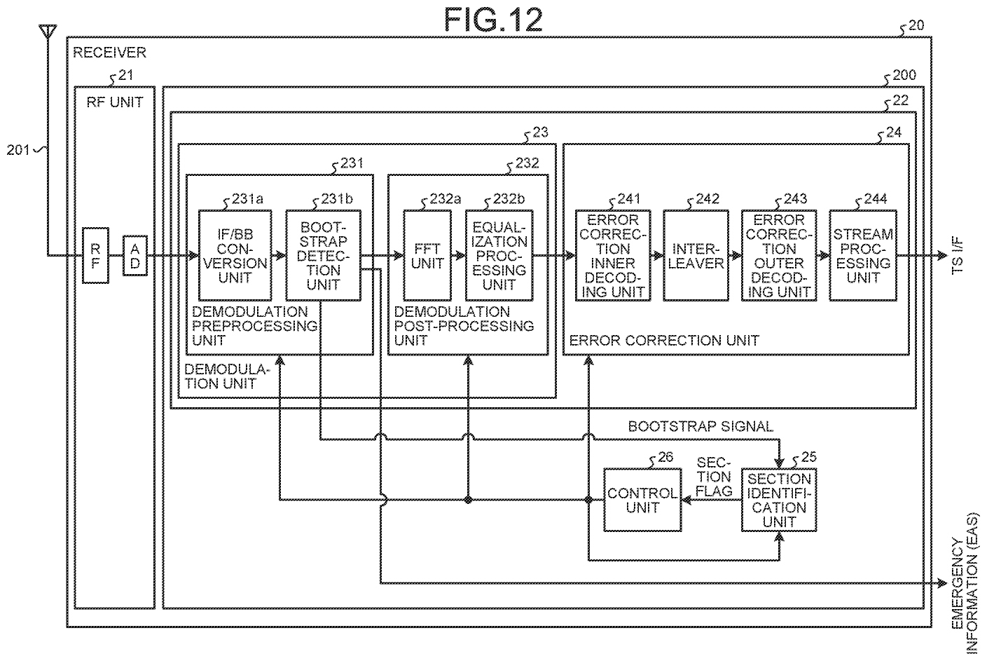

Hereinafter, a configuration of the receiver 20 according to the second embodiment will be described in detail. FIG. 12 is a diagram illustrating the configuration of the receiver 20 according to the second embodiment. As illustrated in FIG. 12, the receiver 20 includes the RF unit 21, the processing unit 22, the section identification unit 25, and the control unit 26. The processing unit 22 includes the demodulation unit 23 and the error correction unit 24. The bootstrap detection unit 231b is configured to demodulate the bootstrap from the OFDM signal and supply a bootstrap signal after demodulation to the section identification unit 25.

The section identification unit 25 identifies the bootstrap section in the frame, on the basis of the bootstrap signal from the bootstrap detection unit 231b. For example, the section identification unit 25 identifies the first section being the bootstrap, on the basis of min_time_to_next in the bootstrap signaling. A method of identifying the first section on the basis of the time interval will be described later. The section identification unit 25 supplies the section flag indicating the first section, to the control unit 26. For example, the section identification unit 25 supplies, to the control unit 26, the section flags indicating the first section of the frame as “H” and the second section different from the first section as “L”.

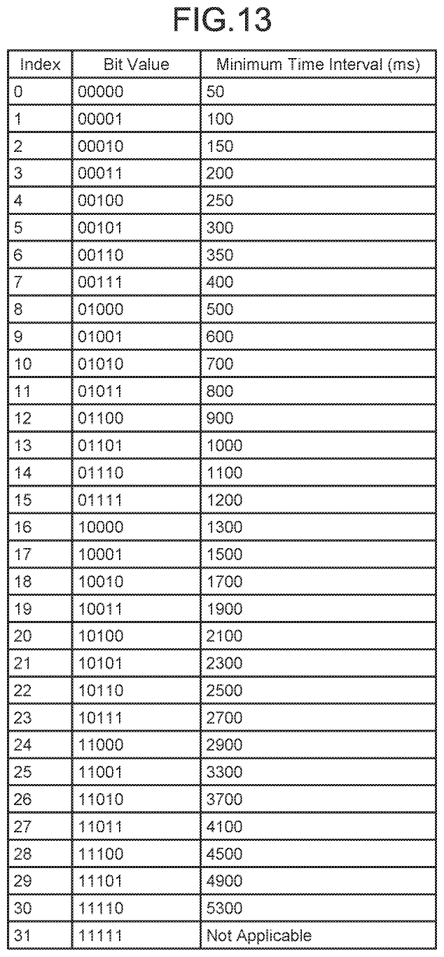

FIG. 13 is a table illustrating a setting example of a minimum time interval of the bootstrap. Values as illustrated in FIG. 13 are set for the minimum time interval (min_time_to_next) of the bootstrap. For example, when “01101” is set for BitValue, the minimum time interval indicates 1000 ms. For example, when “11110” is set for BitValue, the minimum time interval indicates 5300 ms. The section identification unit 25 identifies the first section of the frame, on the basis of the value indicated by the minimum time interval of the bootstrap. For example, in a frame time (Time), the section identification unit 25 identifies, as the second section, a time indicated by the minimum time interval from the tail end of the frame and identifies the remaining time as the first section. The section identification unit 25 supplies the section flag indicating the first section in the frame time, to the control unit 26. For example, the section identification unit 25 supplies, to the control unit 26, the section flags indicating the first section of the frame as “H” and the second section different from the first section as “L”.

Note that the minimum time interval of the bootstrap merely represents the minimum time interval, and there is a possibility that 100 ms would be actually set for an interval of 1 sec. Therefore, when the value of the minimum time interval is not more than a predetermined threshold, the section identification unit 25 may identify the first section on the basis of the frame length of the frame, as in the first embodiment described above.

The configuration example of the receiver 20 according to the embodiment has been described above. Note that the configuration described above with reference to FIG. 12 is merely an example, and the configuration of the receiver 20 according to the second embodiment is not limited to such an example. The functional configuration of the receiver 20 according to the present embodiment can be flexibly modified according to specifications and operations.

### Procedure Performed by Receiver According to Second Embodiment

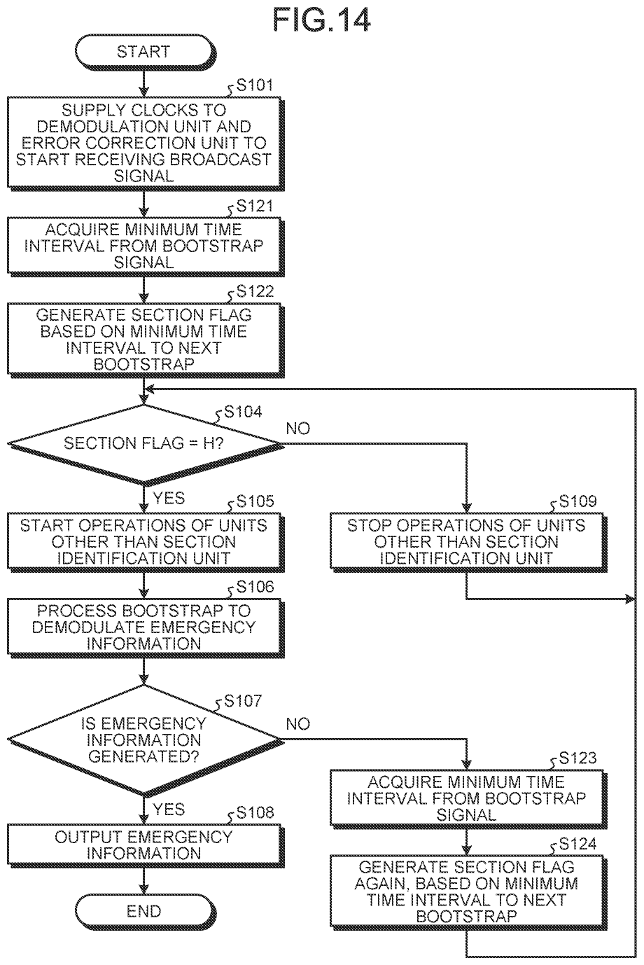

Next, an example of a procedure performed by the receiver 20 according to the second embodiment will be described with reference to FIG. 14. FIG. 14 is a flowchart illustrating an example of the procedure performed by the receiver 20 according to the second embodiment. The procedure illustrated in FIG. 14 is implemented by execution of a program during the standby state of the receiver 20. The procedure illustrated in FIG. 14 is not performed while the receiver 20 receives the broadcast.

As illustrated in FIG. 14, the receiver 20 supplies clocks to the demodulation unit 23 and the error correction unit 24 to start receiving the broadcast signal (received signal) (Step S101). Therefore, the receiver 20 starts receiving the ATSC 3.0 broadcast signal. The receiver 20 acquires the minimum time interval from the bootstrap signal (Step S121). For example, the receiver 20 acquires, as the minimum time interval, a time corresponding to a value set to the minimum time interval (min_time_to_next) in the bootstrap. The receiver 20 generates the section flag on the basis of the minimum time interval to the next bootstrap (Step S122).

The receiver 20 determines whether the section flag indicates “H” (Step S104). When it is determined that the section flag indicates “H” (Yes in Step S104), the frame of the broadcast signal represents the first section, and thus, the receiver 20 proceeds to Step S105.

The receiver 20 starts the operations of the units other than the section identification unit 25 (Step S105). For example, since the section identification unit 25 is operating, the receiver 20 supplies clocks to the demodulation unit 23 and the error correction unit 24 to start the operations thereof. The receiver 20 processes the bootstrap to demodulate the emergency information (Step S106).

The receiver 20 determines whether the emergency information is generated (Step S107). When it is determined that the emergency information is not generated (No in Step S107), the receiver 20 proceeds to Step S123. The receiver 20 acquires the minimum time interval from the bootstrap signal (Step S123). The receiver 20 generates the section flag again on the basis of the minimum time interval to the next bootstrap (Step S124). In other words, a series of the processing from Step S123 to Step S124 is processing for the next bootstrap. When the processing in Step S124 is finished, the receiver 20 returns to Step S104, which has already been described, and repeats the processing in Step S104 and subsequent steps.

When it is determined that the emergency information is generated (Yes in Step S107), the receiver 20 proceeds to Step S108. The receiver 20 outputs the emergency information (Step S108). When the processing in Step S108 is finished, the receiver 20 finishes the procedure illustrated in FIG. 14.

When it is determined that the section flag does not indicate “H” (No in Step S104), the frame of the broadcast signal does not represent the first section, and thus, the receiver 20 proceeds to Step S109. The receiver 20 stops the operations of the units other than the section identification unit 25 (Step S109). The receiver 20 returns to Step S104, which has already been described, and repeats the processing in Step S104 and subsequent steps.

### Operation of Receiver According to Second Embodiment

Next, an example of the operation of the receiver 20 according to the second embodiment will be described. During the standby state, the receiver 20 receives the broadcast signal, demodulation thereof is performed by the demodulation unit 23, and error correction thereof is performed by the error correction unit 24. In the receiver 20, the first section SE1 and the second section SE2 in the frame are identified on the basis of the minimum time interval of the bootstrap by the section identification unit 25. In the receiver 20, when a time to the next bootstrap is determined, the position of the bootstrap in the frame is determined. Therefore, for the subsequent received signals, the receiver 20 is configured so that the control unit 26 causes the demodulation unit 23, the error correction unit 24, and the section identification unit 25 to operate, in the first section SE1 for each frame. The receiver 20 is configured so that the control unit 26 stops the operations of the demodulation unit 23 and the error correction unit 24 and operates the section identification unit 25, in the second section SE2 for each frame. Accordingly, during the standby state, the receiver 20 is operable to stop the operations of the demodulation unit 23 and the error correction unit 24 in the second section of the frame, suppressing the power consumption, as compared with operating the demodulation unit 23 and the error correction unit 24 at all times.

Note that it is not necessary for the respective steps relating to the processing of the receiver 20 described herein to be processed in time series in the order described in the flowchart. For example, the respective steps relating to the processing of the receiver 20 may be performed in an order different from that described in the flowchart, or may be performed in parallel.

Incidentally, a series of the processing described above can be executed by hardware or software. In a case where the series of processing is executed by the software, a program constituting the software is installed on a computer. Here, examples of the computer include a computer that is incorporated in dedicated hardware, a general-purpose computer that is configured to execute various functions by installing various programs, and the like.

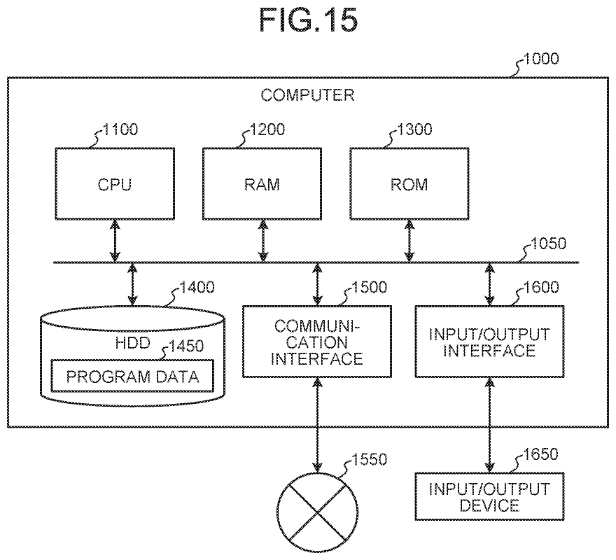

FIG. 15 is a block diagram illustrating a configuration example of the hardware of the computer that performs a series of the processing described above by using the program. A computer 1000 illustrated in FIG. 15 includes a CPU 1100, a RAM 1200, a read only memory (ROM) 1300, a hard disk drive (HDD) 1400, a communication interface 1500, and an input/output interface 1600. The component units of the computer 1000 are connected by a bus 1050.

The CPU 1100 is operated on the basis of a program stored in the ROM 1300 or the HDD 1400 and controls each unit. For example, the CPU 1100 deploys programs stored in the ROM 1300 or the HDD 1400 on the RAM 1200 and executes processing corresponding to various programs.

The ROM 1300 stores a boot program such as a basic input output system (BIOS) executed by the CPU 1100 when the computer 1000 is booted, a program depending on hardware of the computer 1000, and the like.

The HDD 1400 is a computer-readable recording medium that non-transitorily records programs executed by the CPU 1100, data used by the programs, and the like. Specifically, the HDD 1400 is a recording medium that records an information processing program according to the present disclosure, the information processing program being an example of program data 1450.

The communication interface 1500 is an interface that connects the computer 1000 to an external network 1550 (e.g., the Internet). For example, the CPU 1100 receives data from another device or transmits data generated by the CPU 1100 to another device via the communication interface 1500.

The input/output interface 1600 is an interface for connecting an input/output device 1650 to the computer 1000. For example, the CPU 1100 receives data from an input device such as a keyboard or mouse via the input/output interface 1600. In addition, the CPU 1100 transmits data to an output device such as a display, speaker, or printer via the input/output interface 1600. Furthermore, the input/output interface 1600 may function as a media interface that reads a program or the like recorded on a predetermined recording medium. An example of the medium includes an optical recording medium such as a digital versatile disc (DVD), a magneto-optical recording medium such as a magneto-optical disk (MO), a tape medium, a magnetic recording medium, a semiconductor memory, or the like.

For example, when the computer 1000 functions as the receiver 20 according to the embodiments, the CPU 1100 of the computer 1000 implements the functions of the section identification unit 25, the control unit 26, and the like by executing the programs loaded on the RAM 1200. Furthermore, the HDD 1400 stores a program according to the present disclosure or data of the receiver 20. Note that the CPU 1100 executes the program data 1450 read from the HDD 1400, but in another example, the CPU 1100 may acquire these programs from another device via the external network 1550.

Preferred embodiments of the present disclosure have been described above in detail with reference to the accompanying drawings, but the technical scope of the present disclosure is not limited to these examples. A person skilled in the art may obviously find various alternations and modifications within the technical concept described in claims, and it should be understood that they will naturally come under the technical scope of the present disclosure.

Furthermore, the effects descried herein are merely explanatory or exemplary effects, and not limitative. In other words, the technology according to the present disclosure can achieve other effects that are apparent to those who skilled in the art from the description herein, along with or instead of the above effects.

Furthermore, it is also possible to create a program for causing hardware such as a CPU, ROM, and RAM built in a computer to exhibit functions equivalent to those of the configuration of the receiver 20. Furthermore, it is possible to provide a computer-readable recording medium having the program recorded thereon.

### Effects

The receiver 20 includes the processing unit 22 that processes the received signal including the plurality of frames, the section identification unit 25 that identifies the first section being the bootstrap in each frame on the basis of the received signal, and the control unit 26 that operates the processing unit 22 in the first section of the frame and does not operate the processing unit 22 in the second section of the frame different from the first section during the standby state.

Due to this configuration, the receiver 20 identifies the first section being the bootstrap in the frame by using the section identification unit 25. In the receiver 20, the control unit 26 is allowed to control the processing unit 22 to operate in the first section of the frame and not to operate in the second section of the frame different from the first section, during the standby state. Accordingly, during the standby state, the receiver 20 is operable to stop the operation of the processing unit 22 in the second section of the frame, suppressing the power consumption, as compared with operating the processing unit 22 at all times.

In the receiver 20, the processing unit 22 includes the demodulation unit 23 and the error correction unit 24, and during the standby state, the control unit 26 stops at least one of the demodulation unit and the error correction unit in the second section of the frame, not operating the processing unit 22.

Due to this configuration, during the standby state, the receiver 20 stops at least one of the demodulation unit 23 and the error correction unit 24 in the second section of the frame, not operating the processing unit 22. Accordingly, the receiver 20 is operable to partially stop the operation of the processing unit 22, suppressing the power consumption during the standby state without complicating the processing.

In the receiver 20, during the standby state, the demodulation unit 23 outputs the emergency information when the emergency information is set in the bootstrap of the received signal.

This configuration makes it possible for the receiver 20 to continue to receive the received signal and output the emergency information set in the bootstrap, during the standby state. Accordingly, the receiver 20 is operable to output the emergency information, even when the operation of the processing unit 22 is stopped during the standby state, thus suppressing the power consumption while continuously receiving the emergency signal.

In the receiver 20, the frame includes the bootstrap, the preamble, and one or more subframes, and the section identification unit 25 calculates the frame length of the frame, on the basis of the lengths of the bootstrap, the preamble, and the subframes to identify the first section on the basis of the frame length.

This configuration makes it possible for the receiver 20 to calculate the frame length of the frame on the basis of the lengths of the bootstrap, the preamble, and the subframes to identify the first section of the frame on the basis of the frame length. Accordingly, the receiver 20 enables to identify the first section of the frame even when the length of the frame changes, and thus, power consumption can be suppressed in the standby state.

In the receiver 20, the section identification unit 25 identifies the first section in the frame, on the basis of the time interval to the next bootstrap that is set in the bootstrap.

This configuration makes it possible for the receiver 20 to identify the first section of the frame, on the basis of the time interval set in the bootstrap. Accordingly, the receiver 20 enables to identify the first section of the frame even when the time interval of the bootstrap changes, and thus, power consumption can be suppressed in the standby state.

In the receiver 20, the processing unit 22 performs the processing described above on the basis of supply of the clocks, and the control unit 26 stops the supply of the clocks to the processing unit 22 in the first section, during the standby state, and does not operate the processing unit 22.

This configuration makes it possible for the receiver 20 to supply the clocks to the processing unit 22 in the first section and stop the supply of the clocks to the processing unit 22 in the second section, during the standby state, thus stopping the operation of the processing unit in the second section. Accordingly, the receiver 20 is operable to control the operation of the processing unit 22 in the standby state by controlling the supply of the clocks, thus, reducing the processing load on the control unit 26.

In the receiver 20, the frame is a physical layer frame defined in ATSC 3.0.

Therefore, in the receiver 20, the control unit 26 is allowed to control the processing unit 22 to operate in the first section of the ATSC 3.0 physical frame and not to operate in the second section of the physical frame different from the first section, during the standby state. Accordingly, during the standby state, the receiver 20 is operable to stop the operation of the processing unit 22 in the second section of the physical frame, suppressing the power consumption, as compared with operating the processing unit 22 at all times.

A reception method performed by the receiver 20 including the processing unit 22 that processes a received signal including a plurality of frames, and the reception method includes identifying the first section being the bootstrap in each of the frames on the basis of the received signal, and operating the processing unit 22 in the first section of the frame and not operating the processing unit 22 in the second section of the frame different from the first section during a standby state.

Therefore, in the reception method, when the receiver 20 identifies the first section being the bootstrap in the frame, during the standby state, the processing unit 22 is operated in the first section of the frame, and the processing unit 22 is not operated in the second section of the frame different from the first section. Accordingly, in the reception method, during the standby state of the receiver 20, stopping the operation of the processing unit 22 in the second section of the frame makes it possible to suppress the power consumption, as compared with operating the processing unit 22 at all times.

A program causes the receiver including the processing unit 22 that processes a received signal including a plurality of frames to execute the steps of identifying the first section being the bootstrap in each of the frames on the basis of the received signal, and operating the processing unit 22 in the first section of the frame and not operating the processing unit 22 in the second section of the frame different from the first section during a standby state.

Due to this configuration, the program causes the receiver 20 to identify the first section being the bootstrap in the frame, the program causes the receiver 20 to implement control to operate the processing unit 22 in the first section of the frame and not to operate the processing unit 22 in the second section of the frame different from the first section, during the standby state. Accordingly, during the standby state of the receiver 20, the program makes it possible to stop the operation of the processing unit 22 in the second section of the frame, suppressing the power consumption, as compared with operating the processing unit 22 at all times

Additionally, the following configurations also come under the technical scope of the present disclosure.

(1)

A receiver comprising:

a processing unit that processes a received signal including a plurality of frames;

a section identification unit that identifies a first section being a bootstrap in each of the frames based on the received signal; and

a control unit that operates the processing unit in the first section of the frame and does not operate the processing unit in a second section of the frame different from the first section during a standby state.

(2)

The receiver according to (1), wherein

the processing unit includes a demodulation unit and an error correction unit, and

the control unit, during the standby state, stops at least one of the demodulation unit and the error correction unit in the second section of the frame, not operating the processing unit.

(3)

The receiver according to (2), wherein

when emergency information is set in the bootstrap of the received signal, the demodulation unit outputs the emergency information, in the standby state.

(4)

The receiver according to any one of (1) to (3), wherein

the frame includes the bootstrap, a preamble, and one or more subframes, and

the section identification unit calculates a frame length of the frame based on lengths of the bootstrap, the preamble, and the subframes to identify the first section based on the frame length.

(5)

The receiver according to any one of (1) to (3), wherein

the section identification unit identifies the first section in the frame, based on a time interval to a next bootstrap that is set in the bootstrap.

(6)

The receiver according to any one of (1) to (3), wherein

the processing unit performs the processing based on supply of clocks, and

the control unit stops the supply of the clocks to the processing unit in the second section during the standby state, and does not operate the processing unit.

(7)

The receiver according to any one of (1) to (6), wherein

the frame is a physical layer frame defined in Advanced Television Systems Committee (ATSC) 3.0.

(8)

A reception method performed by a receiver including a processing unit that processes a received signal including a plurality of frames, the method comprising:

a step pf identifying a first section being a bootstrap in each of the frames based on the received signal; and

a step pf operating the processing unit in the first section of the frame and not operating the processing unit in a second section of the frame different from the first section during a standby state.

(9)

A reception program causing a receiver including a processing unit that processes a received signal including a plurality of frames to perform

a step pf identifying a first section being a bootstrap in each of the frames based on the received signal, and

a step pf operating the processing unit in the first section of the frame and not operating the processing unit in a second section of the frame different from the first section during a standby state.

### REFERENCE SIGNS LIST

1 TRANSMISSION SYSTEM
10 TRANSMITTER
20 RECEIVER
21 RF UNIT
22 PROCESSING UNIT
23 DEMODULATION UNIT
24 ERROR CORRECTION UNIT
25 SECTION IDENTIFICATION UNIT
26 CONTROL UNIT
231 DEMODULATION PREPROCESSING UNIT
231a IF/BB CONVERSION UNIT
231b BOOTSTRAP DETECTION UNIT
232 DEMODULATION POST-PROCESSING UNIT
232a FFT UNIT
232b EQUALIZATION PROCESSING UNIT
241 ERROR CORRECTION INNER DECODING UNIT
242 INTERLEAVER
243 ERROR CORRECTION OUTER DECODING UNIT
244 STREAM PROCESSING UNIT

1. A receiver comprising:
a processing unit that processes a received signal including a plurality of frames;
a section identification unit that identifies a first section being a bootstrap in each of the frames based on the received signal; and
a control unit that operates the processing unit in the first section of the frame and does not operate the processing unit in a second section of the frame different from the first section during a standby state.

2. The receiver according to claim 1, wherein
the processing unit includes a demodulation unit and an error correction unit, and
the control unit, during the standby state, stops at least one of the demodulation unit and the error correction unit in the second section of the frame, not operating the processing unit.

3. The receiver according to claim 2, wherein
when emergency information is set in the bootstrap of the received signal, the demodulation unit outputs the emergency information, in the standby state.

4. The receiver according to claim 3, wherein
the frame includes the bootstrap, a preamble, and one or more subframes, and
the section identification unit calculates a frame length of the frame based on lengths of the bootstrap, the preamble, and the subframes to identify the first section based on the frame length.

5. The receiver according to claim 3, wherein
the section identification unit identifies the first section in the frame, based on a time interval to a next bootstrap that is set in the bootstrap.

6. The receiver according to claim 3, wherein
the processing unit performs the processing based on supply of clocks, and
the control unit stops the supply of the clocks to the processing unit in the second section during the standby state, and does not operate the processing unit.

7. The receiver according to claim 1, wherein
the frame is a physical layer frame defined in Advanced Television Systems Committee (ATSC) 3.0.

8. A reception method performed by a receiver including a processing unit that processes a received signal including a plurality of frames, the method comprising:
a step pf identifying a first section being a bootstrap in each of the frames based on the received signal; and
a step pf operating the processing unit in the first section of the frame and not operating the processing unit in a second section of the frame different from the first section during a standby state.

9. A reception program causing a receiver including a processing unit that processes a received signal including a plurality of frames to perform
a step pf identifying a first section being a bootstrap in each of the frames based on the received signal, and
a step pf operating the processing unit in the first section of the frame and not operating the processing unit in a second section of the frame different from the first section during a standby state.
